(19) United States
(12) Patent Application Publication
(10) Pub. No.: US 2026/0079674 A1
(43) Pub. Date: Mar. 19, 2026

(54) MODULO ARITHMETIC DEVICE, MEMORY SYSTEM, AND METHOD

(71) Applicant: Kioxia Corporation, Tokyo (JP)

(72) Inventor: Kazuki INOUE, Kamakura Kanagawa (JP)

(73) Assignee: Kioxia Corporation, Tokyo (JP)

(21) Appl. No.: 19/066,304

(22) Filed: Feb. 28, 2025

(30) Foreign Application Priority Data
Sep. 18, 2024 (JP) 2024-161466

(51) Int. Cl. G06F 7/72; G06F 7/485; G06F 7/523

(52) U.S. Cl. CPC G06F 7/727; G06F 7/485; G06F 7/523

(57) ABSTRACT

According to a modulo arithmetic device of one embodiment, a first intermediate value is acquired by shifting right a dividend by a shift amount w correlated with a bit length of a divisor. The shift amount w takes a value not more than the bit length of the divisor. A second intermediate value is acquired by multiplying the first intermediate value by a value m. A third intermediate value is acquired by shifting right the second intermediate value by a shift amount (2k−w). The parameter k takes a value equal to or larger than the bit length of the divisor. A fourth intermediate value is acquired by multiplying the third intermediate value by the divisor. A fifth intermediate value is acquired by subtracting the fourth intermediate value from the dividend. A remainder is acquired by subtracting a value n-times the divisor from the fifth intermediate value.

### CROSS-REFERENCE TO RELATED APPLICATIONS

This application is based upon and claims the benefit of priority from Japanese Patent Application No. 2024-161466, filed on Sep. 18, 2024, the entire contents of which are incorporated herein by reference.

### FIELD

Embodiments described herein relate generally to a modulo arithmetic device, a memory system, and a method.

### BACKGROUND

A modulo operation is performed in processing using an encryption scheme, such as processing of a digital signature. In a case where the above-described encryption scheme is applied to a memory system, it is desirable that a circuit for a modulo operation is small in area and high in operation speed.

### BRIEF DESCRIPTION OF THE DRAWINGS

FIG. 1 illustrates an exemplary configuration of a memory system including a modulo arithmetic device according to a first embodiment;

FIG. 2 is an explanatory diagram for an exemplary modulo operation according to the first embodiment;

FIG. 3 is a table illustrating an exemplary correspondence relation between the bit length of a value q and various values including a shift amount w according to the first embodiment;

FIG. 4 is an explanatory diagram for the respective possible ranges for the shift amount w and a parameter value k according to the first embodiment;

FIG. 5 is a table illustrating another exemplary correspondence relation between the bit length of the value q and various values including the shift amount w according to the first embodiment;

FIG. 6 illustrates an exemplary configuration of the modulo arithmetic device according to the first embodiment;

FIG. 7 illustrates an exemplary configuration of a first shift circuit block according to the first embodiment;

FIG. 8 illustrates an exemplary configuration of a second shift circuit block according to the first embodiment;

FIG. 9 is a flowchart illustrating an exemplary operation of the modulo arithmetic device according to the first embodiment;

FIG. 10 is an explanatory diagram for the respective possible ranges for a shift amount w and a parameter value k according to a second embodiment;

FIG. 11 is a table illustrating an exemplary correspondence relation between the bit length of a value q and various values including a shift amount w according to the second embodiment;

FIG. 12 is a table illustrating an exemplary correspondence relation between the bit length of a value q and various values including a shift amount w according to a third embodiment;

FIG. 13 illustrates an exemplary configuration of a modulo arithmetic device according to a third embodiment;

FIG. 14 illustrates an exemplary configuration of a first shift circuit block according to the third embodiment;

FIG. 15 illustrates an exemplary configuration of a second shift circuit block according to the third embodiment; and

FIG. 16 illustrates an exemplary configuration of a modulo arithmetic device according to a fourth embodiment.

### DETAILED DESCRIPTION

According to one embodiment, a modulo arithmetic device performs a bitwise operation using a dividend a and a divisor q to calculate a remainder. The modulo arithmetic device includes a first shift circuit, a first multiplication circuit, a second shift circuit, a second multiplication circuit, a subtraction circuit, and a processing circuit. The first shift circuit is configured to acquire a first intermediate value by shifting right the dividend a by a shift amount w correlated with a bit length of the divisor q. The shift amount w takes a value equal to or less than the bit length of the divisor q. The first multiplication circuit is configured to acquire a second intermediate value by multiplying the first intermediate value by a value m. The second shift circuit is configured to acquire a third intermediate value by shifting right the second intermediate value by a shift amount (2k−w), k being a parameter value and taking a value equal to or larger than the bit length of the divisor q. The second multiplication circuit is configured to acquire a fourth intermediate value by multiplying the third intermediate value by the divisor q. The subtraction circuit is configured to acquire a fifth intermediate value by subtracting the fourth intermediate value from the dividend a. The processing circuit is configured to acquire the remainder by subtracting a value n-times the divisor q from the fifth intermediate value, n being an integer of 0 or more.

An encryption scheme for signature processing or the like may be implemented on a memory system, such as a solid state drive (SSD). However, it is thought that practical use of quantum computing endangers some of the existing encryption schemes.

Against such danger, the National Institute of Standards and Technology (NIST) has prepared new encryption schemes. Examples of such new encryption schemes include a module-lattice-based digital signature algorithm (ML-DSA) and a module-lattice-based key encapsulation mechanism (ML-KEM). These new encryption schemes are referred to as post-quantum cryptography. In post-quantum cryptography, a modulo operation is used.

A representative modulo operation used in post-quantum cryptography will be described below. In a case where values x, y, and q meeting the following Expressions (1) and (2) are given, a remainder b is acquired by the operation of the following Expression (3). Note that the value q is a divisor, “*” is an operator for multiplication, and “%” is an operator for a modulo operation.

$$0 \leq x < q \qquad ( 1 )$$

$$0 \leq y < q \qquad ( 2 )$$

$$b = ( x * y ) \% q \qquad ( 3 )$$

The value q is changed with encryption schemes. For example, in ML-DSA, the value q is 8380417. In ML-KEM, the value q is 3329.

An algorithm for the modulo operation described with (1), (2), and (3) is, for example, Barrett reduction. An outline of Barrett reduction will be given below. For the sake of simplification of description, in addition to the values x, y, and q, a value a is introduced as indicated in the following Expression (4). The value a is a dividend in the modulo operation.

$$a = x * y \qquad ( 4 )$$

Note that, as indicated in Expressions (1) and (2), the values x and y are each smaller than q. Therefore, the value a is smaller than a value q².

In Barrett reduction, a parameter value k and a value m meeting the following Expression (5) are used.

$$m / {2}^{2 k} = 1 / q \qquad ( 5 )$$

Expression (6) can be derived from Expression (5).

$$m = ⌊ {2}^{2 k} / q ⌋ \qquad ( 6 )$$

As indicated in Expression (7), a shift operation is performed to shift right the value a by k bits. In Expression (7), “>>” represents an operator for a shift operation.

$${a}^{′} = a >> k \qquad ( 7 )$$

Next, a value a′ is updated using the following Expression (8).

$${a}^{′} = a - ( ( {a}^{′} * m ) >> k ) * q \qquad ( 8 )$$

A value obtained by calculation of ((a′ *m)>>k) on the right side of Expression (8) is an approximate value of the quotient resulting from division of the value a by the value q. Therefore, the value a′ after updating by Expression (8) is the remainder resulting from division of the value a by the value q (namely, the value b in Expression (3)) or the value resulting from addition of a multiple of the value q to the value b. Therefore, the value a′ is determined whether to be equal to or larger than the value q.

In a case where the value a′ is larger than the value q, processing with the following Expression (9) is performed.

$${a}^{′} = {a}^{′} - q \qquad ( 9 )$$

The processing with Expression (9) is repeated until the value a′ becomes smaller than the value q. In a case where the value a′ is smaller than the value q, as indicated in the following Expression (10), the value a′ is determined as the remainder b.

$$b = {a}^{′} \qquad ( 10 )$$

A technique compared to an embodiment will be described. The technique that is compared to an embodiment of the present disclosure is referred to as a comparative example. According to the comparative example, the above-described processing of Barrett reduction is performed by a hardware circuit.

Specifically, the hardware circuit according to the comparative example performs pieces of processing in the following order.
(S201) The values a, q, and m are acquired.
(S202) The parameter value k is acquired using the following Expression (11).

$$k = ⌈ {log}_{2} ( q ) ⌉ \qquad ( 11 )$$

(S203) The value a is shifted right by k bits to acquire the value a′.
(S204) The value a′ is multiplied by the value m.
(S205) The value obtained in Step S204 is further shifted right by k bits.
(S206) The value obtained in Step S205 is multiplied by the value q, and then the value a′ is updated using the value obtained by the multiplication.
(S207) The calculation of Expression (9) is performed to the value a′ until the value a′ becomes smaller than the value q.
(S208) The value a′ is output as the remainder b at the time of division of the value a by the value q.

Note that the processing in Step S207 is referred to as correction processing herein.

In general, the calculation cost required for division is high. According to the comparative example, the calculation of Expression (6) including division is performed outside the hardware circuit. Therefore, a modulo operation can be implemented at a lower calculation cost.

However, according to the comparative example, a shift operation is performed in Step S203 and in Step S205. Then, as is clear from Expression (11), the parameter value k used as a shift amount is a variable amount depending on the bit length of the value q. For example, in a case where a possible range for the bit length of the value q is a range of 1 to 32, the parameter value k is allowed to take 32 types of values. Thus, according to the comparative example, the number of variations for the shift amount in the shift operation is 32.

Regarding a circuit for the shift operation, an increase in the number of variations manageable for the shift amount causes an increase in the area of the circuit and an increase in the time required for the shift operation. A series of processing that the hardware circuit according to the comparative example performs includes the shift operation having a relatively large number of variations for the shift amount, and thus the hardware circuit according to the comparative example has large circuit area and needs much time for a modulo operation.

According to an embodiment, the number of variations for the shift amount in a shift operation is less than that according to the comparative example. Thus, a hardware circuit can be provided that is smaller in circuit area than that according to the comparative example and can perform a high-speed modulo operation. Here, for example, the hardware circuit may be implemented by at least one of a register, a memory, an adder, a multiplier, a selector, and other arithmetic units. The register is implemented by, for example, a sequential circuit such as a flip-flop. The adder, the multiplier, the selector, and the other arithmetic units may be implemented by a combinational logic circuit.

A modulo arithmetic device as a hardware circuit, a memory system including the modulo arithmetic device, and a method according to embodiments will be described in detail below with reference to the accompanying drawings. As an exemplary modulo arithmetic device according to an embodiment, a modulo arithmetic device implemented on a memory system will be described below. Note that a modulo arithmetic device according to an embodiment may be installed in any system different from memory systems. The present disclosure is not limited to the following embodiments.

### First Embodiment

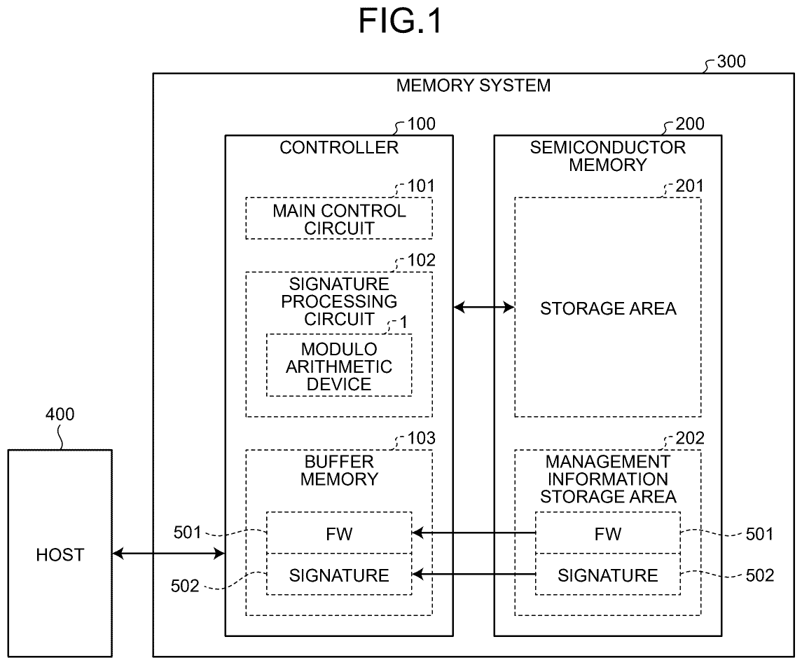

FIG. 1 illustrates an exemplary configuration of a memory system including a modulo arithmetic device 1 according to a first embodiment.

A memory system 300 is connectable to a host 400. The host 400 corresponds to, for example, a server, a personal computer, or a mobile information processing apparatus. The memory system 300 functions as an external memory device for the host 400.

The memory system 300 includes a controller 100 and a semiconductor memory 200. The controller 100 includes a main control circuit 101, a signature processing circuit 102, and a buffer memory 103. The signature processing circuit 102 includes the modulo arithmetic device 1 as a hardware circuit that performs a modulo operation. The semiconductor memory 200 serves as a nonvolatile semiconductor memory (e.g., a NAND flash memory) and includes a storage area 201 and a management information storage area 202. User data is allowed to be stored in the storage area 201. Firmware (FW) 501 and a signature 502 are stored in the management information storage area 202. The signature 502 is a digital signature. The signature processing circuit 102 generates the signature 502 in accordance with a predetermined encryption scheme.

The predetermined encryption scheme is ML-DSA or ML-KEM. Note that an encryption scheme applicable to the memory system 300 is not limited to these schemes.

In the memory system 300, at the time of activation of the firmware 501, the controller 100 temporarily stores the firmware 501 and the signature 502 into the buffer memory 103 and the signature processing circuit 102 performs signature verification processing for the firmware 501. In the signature verification processing, the hash value of the firmware 501 is found and additionally a value based on a public key is extracted from the signature 502, and then whether or not a predetermined condition is met is determined using the hash value of the firmware 501 and the extracted value.

In a case where the predetermined condition is met, the signature processing circuit 102 determined that no illegal falsification has been made and then outputs a result of approval. In response to the result, the controller 100 activates the firmware 501 to load a functional module for the firmware 501 in the buffer memory 103, for example. Then, the controller 100 starts data transfer between the host 400 and the storage area 201 responsive to a command from the host 400. In a case where the predetermined condition is not met, the signature processing circuit 102 determines that illegal falsification may have been made and then outputs a result of refusal. In response to the result, the controller 100 does not activate the firmware 501. As a result, the memory system 300 enables detection/prevention of illegal falsification for the firmware 501 at the time of activation.

In generating the signature 502 and in the signature verification processing, the signature processing circuit 102 performs a modulo operation using the modulo arithmetic device 1.

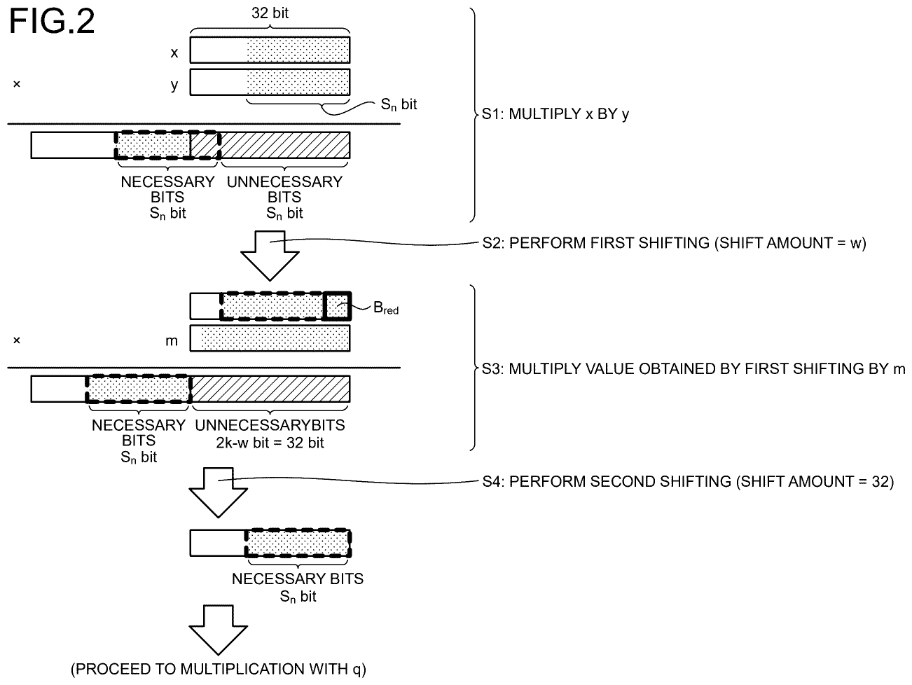

FIG. 2 is an explanatory diagram for an exemplary modulo operation according to the first embodiment.

The signature processing circuit 102 generates values x, y, m, and q. The values x, y, and q meet Expressions (1) and (2).

In the example illustrated in FIG. 2, the respective bit widths of data paths for transmission of the values x, y, and q are 32 bits. From the relation between Expressions (1) and (2), it can be thought that the values x and y each include significant data in the range of the lower Sₙ bits in 32 bits corresponding to the respective bit widths of the data paths for transmission of the values x and y. Note that Sₙ is given by the following Expression (12).

$${S}_{n} = ⌈ {log}_{2} ( q ) ⌉ \qquad ( 12 )$$

The signature processing circuit 102 multiplies the value x by the value y (S1). A value a obtained by the multiplication is transmitted through a data path having a 64-bit width. The value a obtained by multiplying the value x by the value y has a significant value in the range of the lower (2*Sₙ) bits in 64 bits corresponding to the bit width of the data path for transmission of the value a.

According to the comparative example, the first right shift operation truncates the lower Sₙ bits in the range of the (2*Sₙ) bits in which the significant value exists. Thus, it can be thought that the upper Sₙ bits are necessary bits and the lower Sₙ bits are unnecessary bits in the range of the (2*Sₙ) bits in which the significant value exists.

In an embodiment, the modulo arithmetic device 1 performs the first shift operation while keeping part of the unnecessary bits (B_{red} in FIG. 2) (S2). The shift amount in the first shift operation is denoted with w. Thus, in Step S2, the modulo arithmetic device 1 performs a shift operation to shift right the value a by the shift amount w.

The value of the shift amount w is determined depending on the bit length of the value q.

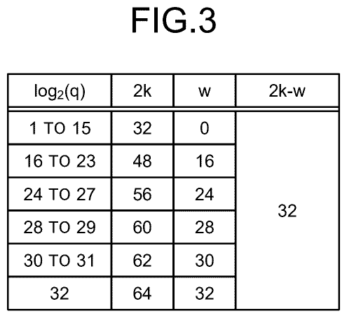

FIG. 3 is a table illustrating an exemplary correspondence relation between the bit length of the value q and various values including the shift amount w according to the first embodiment.

In the example illustrated in FIG. 3, in a case where the bit length of the value q is any of 1 to 15, the shift amount w is zero. In a case where the bit length of the value q is any of 16 to 23, the shift amount w is 16. In a case where the bit length of the value q is any of 24 to 27, the shift amount w is 24. In a case where the bit length of the value q is 28 or 29, the shift amount w is 28. In a case where the bit length of the value q is 30 or 31, the shift amount w is 30. In a case where the bit length of the value q is 32, the shift amount w is 32.

Moreover, a parameter value k (more accurately, the value of 2k) and the value of (2k−w) according to an embodiment are indicated in FIG. 3. In a case where the bit length of the value q is any of 1 to 15, the value of 2k is 32. In a case where the bit length of the value q is any of 16 to 23, the value of 2k is 48. In a case where the bit length of the value q is any of 24 to 27, the value of 2k is 56. In a case where the bit length of the value q is 28 or 29, the value of 2k is 60. In a case where the bit length of the value q is 30 or 31, the value of 2k is 62. In a case where the bit length of the value q is 32, the value of 2k is 64. In this way, the combinations of the possible values for the shift amount w and the possible values for the parameter value k are set. Therefore, the value of (2k−w) is set to 32 regardless of the bit length of the value q.

The number of variations for the bit length of the value q is 32, whereas the number of variations for the shift amount w is set to be considerably less than the number of variations for the bit length of the value q. Therefore, the area of a circuit for the first shift operation (first shift circuit block 11 described later) can be suppressed and additionally the time required for the first shift operation can be suppressed.

Note that the value of (2k−w) indicates the shift amount in the second shift operation. The correspondence relation between the possible values for the bit length of the value q and the combinations of the possible values for the shift amount w and the possible values for the parameter value k is set as illustrated in FIG. 3. Thus, the number of variations for the shift amount (2k−w) in the second shift operation is limited to one. With this configuration, the circuit area of a circuit for the second shift operation (second shift circuit block 13 described later) can be suppressed and additionally the time required for the second shift operation can be suppressed.

Referring back to FIG. 2, further description will be given. After the processing in Step S2, the modulo arithmetic device 1 multiplies the value obtained by the first shift operation by the value m (Step S3).

The value m is calculated in advance based on Expression (6) outside the modulo arithmetic device 1 (herein, by the signature processing circuit 102).

Note that the parameter value k is included in the right side of Expression (6). The signature processing circuit 102 acquires the parameter value k based on, for example, the bit length of the value q and the correspondence relation illustrated in FIG. 3. Then, the signature processing circuit 102 calculates the value m by substituting the acquired parameter value k and the value q into Expression (6). Then, the signature processing circuit 102 inputs the value m obtained by the calculation to the modulo arithmetic device 1. Note that the value m may be calculated by a circuit different from the signature processing circuit 102.

By shifting right the value obtained in Step S3 by (2k−w) bits, a value, which is almost the same as the value obtained in Step S204 by the hardware circuit according to the comparative example, can be obtained. Herein, the shift amount w and the value of 2k are determined such that the value of (2k−w) becomes 32. Therefore, the modulo arithmetic device 1 performs a shift operation to shift right the value obtained in Step S3 by 32 bits (S4).

After the processing in Step S4, the modulo arithmetic device 1 performs processing similar to the processing from Step S206 by the hardware circuit according to the comparative example.

As described above, according to the first embodiment, in comparison to the comparative example, the number of variations for the shift amount in the first shift operation reduces from 32 to 6 and the number of variations for the shift amount in the second shift operation reduces from 32 to 1. Thus, significant reductions can be made in the respective area of the circuits that perform the first and second operations and additionally significant reductions can be made in the respective times required for the first and second shift operations. Therefore, a significant reduction is made in the time required for the modulo operation.

Note that the correspondence relation illustrated in FIG. 3 is just exemplary.

The shift amount w and the parameter value k are selected such that the accuracy of modulo operation is higher than a predetermined level. Thus, regarding the shift amount w and the parameter value k, the restrictions indicated in the following Expressions (13) and (14) are provided.

$$w ≦ ⌈ {log}_{2} ( q ) ⌉ \qquad ( 13 )$$

$$k ≧ ⌈ {log}_{2} ( q ) ⌉ \qquad ( 14 )$$

Expression (13) means that the shift amount w is equal to or less than the bit length of the value q. Expression (14) means that the parameter value k is equal to or larger than the bit length of the value q. In a case where the restriction of Expression (13) is not met, occurrence of underflow causes a deterioration in the accuracy of modulo operation. In a case where the restriction of Expression (14) is not met, disappearance of necessary bits causes a deterioration in the accuracy of modulo operation.

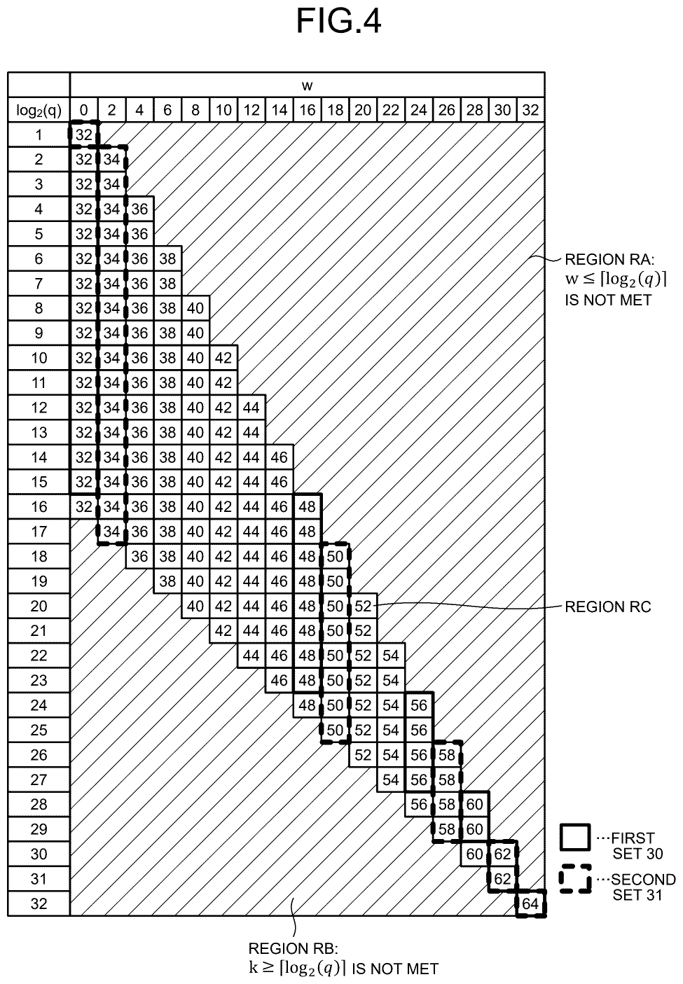

FIG. 4 is an explanatory diagram for the respective possible ranges for the shift amount w and the parameter value k according to the first embodiment. Each cell in FIG. 4 indicates the value of 2k corresponding to the bit length of the value q and the shift amount w. The value of 2k is determined such that the value of (2k−w) is 32 as a fixed value regardless of possible values for the bit length of the value q.

Note that, hereinafter, a combination of the shift amount w and the parameter value k determined such that (2k−w) has a fixed value may be simply referred to as a combination.

Referring to FIG. 4, the combinations included in a region RA do not meet the restriction in Expression (14). In addition, the combinations included in a region RB do not meet the restriction in Expression (13). Therefore, regarding the combinations included in the regions RA and RB, the indication of the value of 2k is omitted. From a region that belongs to neither the region RA nor the region RB, namely, from a region RC, a combination corresponding to a possible value for the bit length of the value q is selected.

Moreover, in order to reduce the number of variations for the shift amount w, two or more possible values for the bit length of the value q are correlated with the same combination. By correlating the possible values for the bit length of the value q, which are as many as possible, with the same combination, the number of variations for the shift amount w can be reduced as much as possible. In the example illustrated in FIG. 4, in a case where a first set 30 or second set 31 is applied as an aggregate of combinations, the number of variations for the shift amount w can be made six as the minimum value.

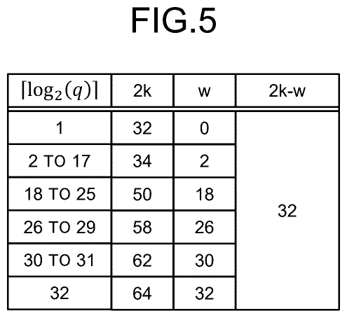

The correspondence relation illustrated in FIG. 3 indicates the correspondence relation in a case where the first set 30 is applied. In a case where the second set 31 is applied, a correspondence relation illustrated in FIG. 5 is set.

FIG. 5 is a table illustrating another exemplary correspondence relation between the bit length of the value q and various values including the shift amount w according to the first embodiment.

In the example illustrated in FIG. 5, in a case where the bit length of the value q is 1, the shift amount w is zero and the value of 2k is 32. In a case where the bit length of the value q is any of 2 to 17, the shift amount w is 2 and the value of 2k is 34. In a case where the bit length of the value q is any of 18 to 25, the shift amount w is 18 and the value of 2k is 50. In a case where the bit length of the value q is any of 26 to 29, the shift amount w is 26 and the value of 2k is 58. In a case where the bit length of the value q is 30 or 31, the shift amount w is 30 and the value of 2k is 62. In a case where the bit length of the value q is 32, the shift amount w is 32 and the value of 2k is 64. The value of (2k−w) is constantly set to 32 regardless of the bit length of the value q, similarly to the example illustrated in FIG. 3.

As described above, even in a case where the second set 31 is applied, the number of variations for the shift amount in the first shift operation can be limited to six and the number of variations for the shift amount in the second shift operation can be limited to one.

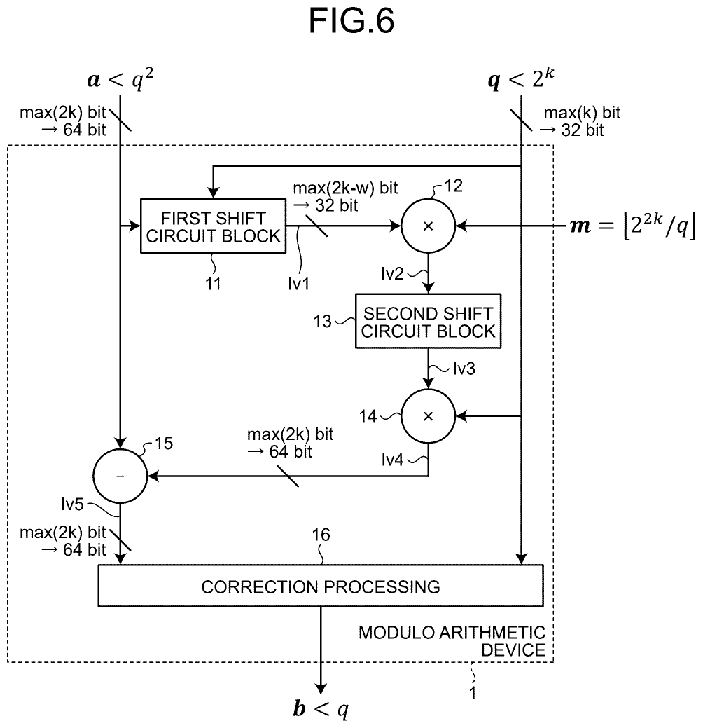

FIG. 6 illustrates an exemplary configuration of the modulo arithmetic device 1 according to the first embodiment. Note that, herein, the correspondence relation illustrated in FIG. 3 is set.

The modulo arithmetic device 1 receives values a, q, and m. The value a is input to the modulo arithmetic device 1 through a data path whose width is 64 bits, which corresponds to the possible maximum value for the value of 2k. The value q is input to the modulo arithmetic device 1 through a data path whose width is 32 bits corresponding to the possible maximum value for the parameter value k.

The modulo arithmetic device 1 includes a first shift circuit block 11, a first multiplication circuit 12, a second shift circuit block 13, a second multiplication circuit 14, a subtraction circuit 15, and a correction processing circuit 16.

The first shift circuit block 11 receives the values a and q. The first shift circuit block 11 performs a shift operation to shift right the value a by the shift amount w. The value of the shift amount w is correlated with the bit length of the value q based on the correspondence relation exemplified in FIG. 3. The value acquired by the shift operation by the first shift circuit block 11 is referred to as an intermediate value Iv1.

The intermediate value Iv1 is input to the first multiplication circuit 12 through a data path having a 32-bit width. In addition, the value m obtained by calculation of Expression (6) is input to the first multiplication circuit 12. The first multiplication circuit 12 multiplies the intermediate value Iv1 by the value m. The value obtained by the multiplication by the first multiplication circuit 12 is referred to as an intermediate value Iv2.

The intermediate value Iv2 is input to the second shift circuit block 13. The second shift circuit block 13 performs a shift operation to shift right the intermediate Iv2 by (2k−w) bits. Here, the value of (2k−w) is constantly 32 regardless of the bit length of the value q. Therefore, the second shift circuit block 13 shifts right the intermediate value Iv2 by 32 bits. The value obtained by the shift operation by the second shift circuit block 13 is referred to as an intermediate value Iv3.

The intermediate value Iv3 is input to the second multiplication circuit 14. In addition, the value q is input to the second multiplication circuit 14. The second multiplication circuit 14 multiplies the intermediate value Iv3 by the value q. The value obtained by the multiplication by the second multiplication circuit 14 is referred to as an intermediate value Iv4.

The intermediate value Iv4 is input to the subtraction circuit 15 through a data path having a 64-bit width. In addition, the value a is input to the subtraction circuit 15. The subtraction circuit 15 subtracts the intermediate value Iv4 from the value a. The value obtained by the subtraction by the subtraction circuit 15 is referred to as an intermediate value Iv5.

The intermediate value Iv5 is input to the correction processing circuit 16 through a data path having a 64-bit width. In addition, the value q is input to the correction processing circuit 16. The correction processing circuit 16 performs correction processing with the intermediate value Iv5 regarded as a value a′. Thus, the correction processing circuit 16 performs calculation of Expression (9) to the value a′ until the value a′ becomes smaller than the value q.

Note that the correction processing can be regarded as processing of subtracting a value n-times the value q from the value a′. n is a natural number of 0 or more. The correction processing circuit 16 is an exemplary processing circuit.

The correction processing circuit 16 outputs the value a′ after correction processing as a remainder b.

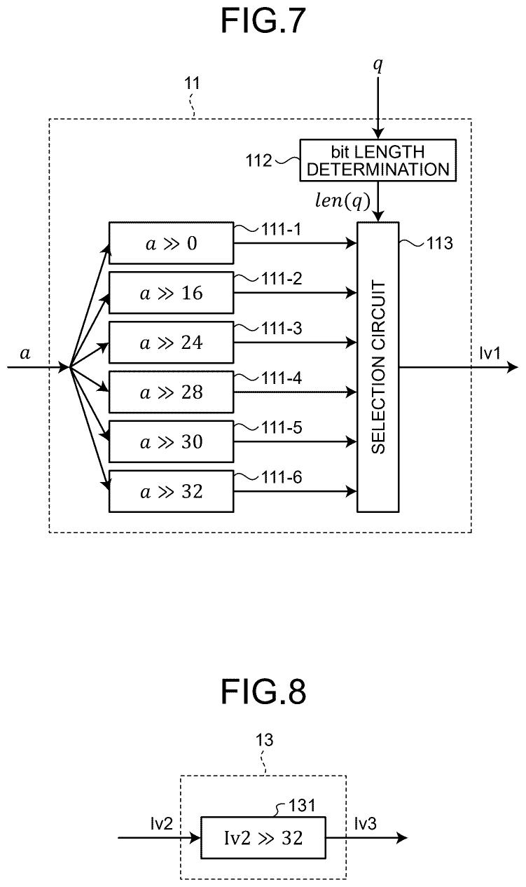

FIG. 7 illustrates an exemplary configuration of the first shift circuit block 11 according to the first embodiment.

The first shift circuit block 11 includes shift circuits 111. The number of the shift circuits 111 corresponds to the number of variations for the shift amount w. Specifically, the first shift circuit block 11 includes, in total, six shift circuits 111 of a shift circuit 111-1, a shift circuit 111-2, a shift circuit 111-3, a shift circuit 111-4, a shift circuit 111-5, and a shift circuit 111-6. Therefore, the first shift circuit block 11 can be regarded as including shift circuits 111, the number of which is less than the number of variations for the bit length of the value q.

The value a is input to each of the six shift circuits 111 in common. The six shift circuits 111 perform respective shift operations, which are different in shift amount, to the value a. The shift amount in the shift operation that the six shift circuits 111 each perform is any of six variations for the shift amount w.

Specifically, the shift circuit 111-1 shifts right the value a by 0 bits. Thus, the shift circuit 111-1 outputs the value a without any change. The shift circuit 111-2 shifts right the value a by 16 bits. The shift circuit 111-3 shifts right the value a by 24 bits. The shift circuit 111-4 shifts right the value a by 28 bits. The shift circuit 111-5 shifts right the value a by 30 bits. The shift circuit 111-6 shifts right the value a by 32 bits.

The first shift circuit block 11 further includes a bit length determination circuit 112 and a selection circuit 113. The six shift circuits 111 are connected to the selection circuit 113.

The value q is input to the bit length determination circuit 112. The bit length determination circuit 112 determines the bit length of the value q. The bit length of the value q is input as a selection signal to the selection circuit 113.

Based on the selection signal and the correspondence relation exemplified in FIG. 3, the selection circuit 113 selects one of the respective output values output by the six shift circuits 111 and outputs the selected output value as the intermediate value Iv1.

Specifically, in a case where the bit length of the value q is any of 1 to 15, the selection circuit 113 outputs, as the intermediate value Iv1, the output value from the shift circuit 111-1. In a case where the bit length of the value q is any of 16 to 23, the selection circuit 113 outputs, as the intermediate value Iv1, the output value from the shift circuit 111-2. In a case where the bit length of the value q is any of 24 to 27, the selection circuit 113 outputs, as the intermediate value Iv1, the output value from the shift circuit 111-3. In a case where the bit length of the value q is 28 or 29, the selection circuit 113 outputs, as the intermediate value Iv1, the output value from the shift circuit 111-4. In a case where the bit length of the value q is 30 or 31, the selection circuit 113 outputs, as the intermediate value Iv1, the output value from the shift circuit 111-5. In a case where the bit length of the value q is 32, the selection circuit 113 outputs, as the intermediate value Iv1, the output value from the shift circuit 111-6.

By configuring the first shift circuit block 11 as described above, a shift operation is performed for the shift amount w corresponding to the bit length of the value q based on the correspondence relation exemplified in FIG. 3.

FIG. 8 illustrates an exemplary configuration of the second shift circuit block 13 according to the first embodiment.

The second shift circuit block 13 includes a shift circuit 131 that shifts right the intermediate value Iv2 by 32 bits. The number of variations for the shift amount in a shift operation by the second shift circuit block 13 is one. Therefore, the second shift circuit block 13 includes no selection circuit, unlike the first shift circuit block 11 in which the number of variations for the shift amount used in the shift operation is more than one.

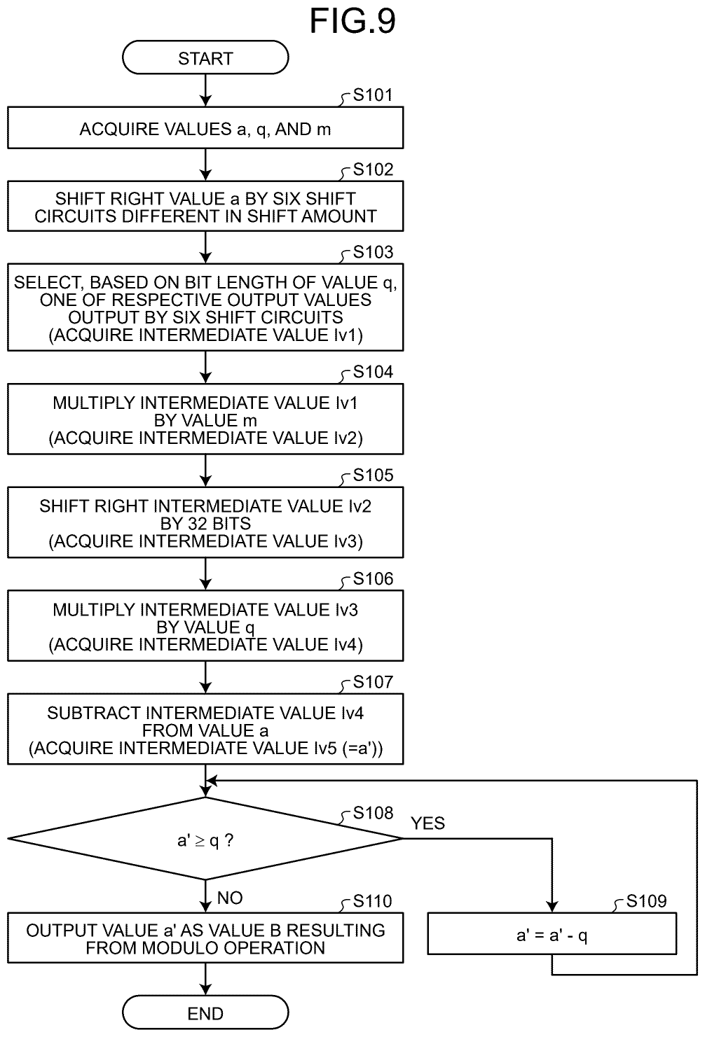

FIG. 9 is a flowchart illustrating an exemplary operation of the modulo arithmetic device 1 according to the first embodiment.

First, the modulo arithmetic device 1 acquires values a, q, and m (S101).

In the first shift circuit block 11, the six shift circuits 111, which are different in shift amount, each shift right the value a (S102). Then, based on the bit length of the value q, the selection circuit 113 selects one of the respective output values output by the six shift circuits 111 (S103). Thus, an intermediate value Iv1 is acquired.

The first multiplication circuit 12 multiplies the intermediate value Iv1 by the value m (S104). Thus, an intermediate value Iv2 is acquired.

In the second shift circuit block 13, the shift circuit 131 shifts right the intermediate value Iv2 by 32 bits (S105). Thus, an intermediate value Iv3 is acquired.

The second multiplication circuit 14 multiplies the intermediate value Iv3 by the value q (S106). Thus, an intermediate value Iv4 is acquired.

The subtraction circuit 15 subtracts the intermediate value Iv4 from the value a (S107). Thus, an intermediate value Iv5, namely, a value a′ is acquired.

The correction processing circuit 16 determines whether or not the value a′ is equal to or larger than the value q (S108).

In a case where the value a′ is equal to or larger than the value q (S108: Yes), the correction processing circuit 16 subtracts the value q from the value a′ and then updates the value a′ by using a result of the subtraction (S109).

In a case where the value a′ is less than the value q (S108: No), the modulo arithmetic device 1 outputs the value a′ as a value b resulting from a modulo operation (S110). Then, a series of processing terminates.

As described above, according to the first embodiment, the first shift circuit block 11 performs a shift operation for right shifting by the shift amount w correlated with the bit length of the value q. The second shift circuit block 13 performs a shift operation to shift right the intermediate value Iv2 by the shift amount (2k−w). The correspondence relation between the possible values for the bit length of the value q and combinations of the possible values for the shift amount w and the possible values for the parameter value k is determined such that a restriction is met. The restriction is defined as that, the shift amount w is equal to or less than the bit length of the value q and the parameter value k is equal to or larger than the bit length of the value q.

Therefore, the number of variations for the shift amount in the shift operation can be made less than that according to the comparative example. The number of variations for the shift amount in the shift operation less than that according to the comparative example enables the modulo arithmetic device 1 to be small in circuit area and to perform a high-speed operation.

In addition, according to the first embodiment, possible values for the bit length of the value q are correlated with the same combination of the value of the shift amount w and the value of the parameter value k. In other words, the correspondence relation between a possible value for the bit length of the value q and a combination of a possible value for the shift amount w and a possible value for the parameter value k is set such that a combination of the value of the shift amount w and the value of the parameter value k in a case where the bit length of the value q is a first value is identical to a combination of the value of the shift amount w and the value of the parameter value k in a case where the bit length of the value q is a second value different from the first value.

Therefore, the number of variations for the shift amount w in the first shift operation can be made less than the number of variations for the bit length of the value q. Therefore, the modulo arithmetic device 1 that is small in circuit area and can perform a high-speed operation can be achieved.

In addition, according to the first embodiment, the correspondence relation between a possible value for the bit length of the value q and a combination of a possible value for the shift amount w and a possible value for the parameter value k is set such that the value of (2k−W) is constant regardless of the bit length of the value q.

Therefore, the number of variations for the shift amount in the second shift operation is limited to one. Therefore, the modulo arithmetic device 1 that is small in circuit area and can perform a high-speed operation can be achieved.

In addition, according to the first embodiment, as described with FIG. 7, the first shift circuit block 11 includes the shift circuits 111, the number of which is less than the number of variations for the bit length of the value q, and the selection circuit 113. The value a is input to each of the shift circuits 111 in common. Based on the bit length of the value q, the selection circuit 113 selects one output value from the respective output values from the shift circuits 111.

Therefore, the number of variations for the shift amount w in the first shift operation can be made less than the number of variations for the bit length of the value q. Therefore, the modulo arithmetic device 1 that is small in circuit area and can perform a high-speed operation can be achieved.

### Second Embodiment

In the first embodiment, the configuration of the modulo arithmetic device 1 having a parameter value k whose maximum value is 32 has been described. Such a parameter value k does not necessarily have a maximum value of 32. In a second embodiment, the configuration of a modulo arithmetic device 1 having a parameter value k whose maximum value is 64 as an exemplary case where a parameter value k does not have a maximum value of 32 will be described. Note that, in the second embodiment, matters different from those in the first embodiment will be described. Matters the same as those in the first embodiment will be omitted or will be briefly described.

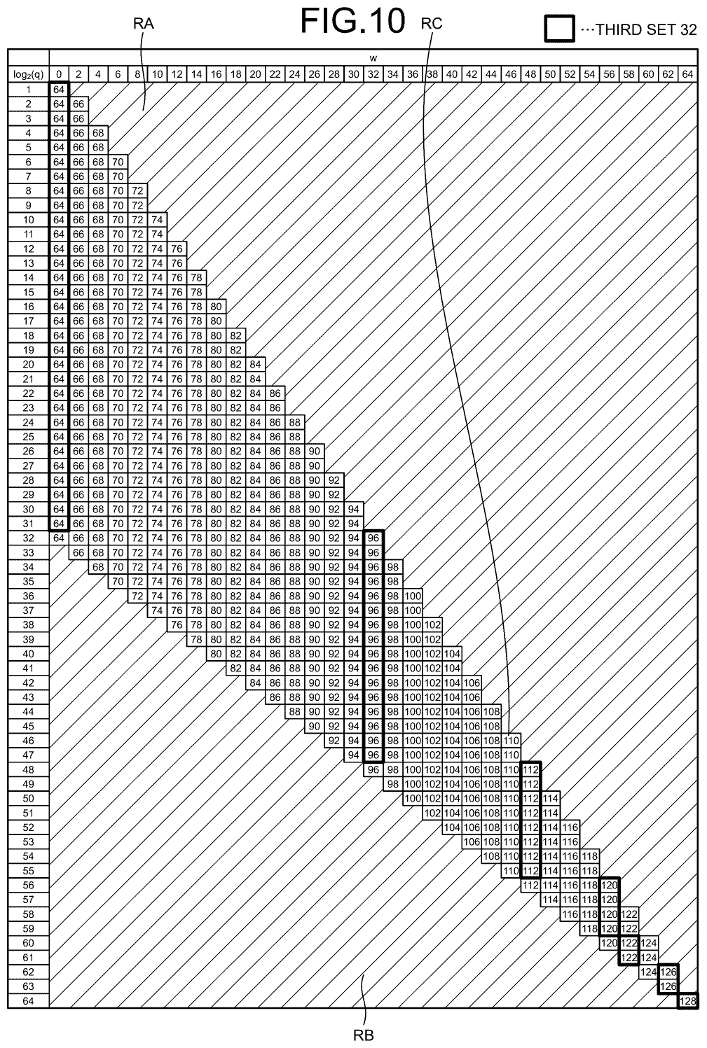

FIG. 10 is an explanatory diagram for the respective possible ranges for a shift amount w and a parameter value k according to the second embodiment. Each cell in FIG. 10 indicates the value of 2k corresponding to the bit length of a value q and the shift amount w. The value of 2k is determined such that the value of (2k−w) is 64 as a fixed value regardless of the possible value for the bit length of the value q. Regarding combinations included in a region RA and a region RB, the indication of the value of 2k is omitted.

Even in a case where the maximum value of the parameter value k is 64, a combination of the shift amount w and the parameter value k is selected such that the restrictions in Expressions (13) and (14) are met. Therefore, a combination corresponding to a possible value for the bit length of the value q is selected from a region RC.

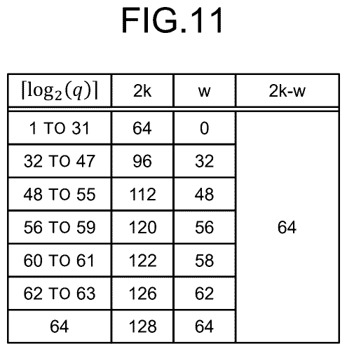

Moreover, in order to reduce the number of variations for the shift amount w, possible values for the bit length of the value q are correlated with the same combination. As many values as possible that the bit length of the value q is allowed to take are correlated with the same combination, so that the number of variations for the shift amount w can be reduced as much as possible. In the example illustrated in FIG. 10, in a case where a third set 32 is applied, the number of variations for the shift amount w can be made seven as the maximum value. In a case where the third set 32 is applied, the correspondence relation illustrated in FIG. 11 is set.

FIG. 11 is a table illustrating an exemplary correspondence relation between the bit length of the value q and various values including the shift amount w according to the second embodiment.

In the example illustrated in FIG. 11, in a case where the bit length of the value q is any of 1 to 31, the shift amount w is zero and the value of 2k is 64. In a case where the bit length of the value q is any of 32 to 47, the shift amount w is 32 and the value of 2k is 96. In a case where the bit length of the value q is any of 48 to 55, the shift amount w is 48 and the value of 2k is 112. In a case where the bit length of the value q is any of 56 to 59, the shift amount w is 120 and the value of 2k is 56. In a case where the bit length of the value q is 60 or 61, the shift amount w is 58 and the value of 2k is 122. In a case where the bit length of the value q is 62 or 63, the shift amount w is 62 and the value of 2k is 126. In a case where the bit length of the value q is 64, the shift amount w is 64 and the value of 2k is 128. The value of (2k−w) is constantly 64 regardless of the bit length of the value q.

Therefore, in a case where the correspondence relation exemplified in FIG. 11 is used, the number of variations for the shift amount in the first shift operation can be limited to seven and the number of variations for the shift amount in the second shift operation can be limited to one.

### Third Embodiment

According to the first embodiment and the second embodiment, all the possible values for the bit length of the value q are correlated with the same value of (2k−w). However, by correlating at least two or more of the possible values for the bit length of the value q with the same value of (2k−w), the number of variations for the shift amount (2k−w) can be reduced.

In a third embodiment, an exemplary configuration in which the number of variations for a shift amount (2k−w) is two will be described. Note that, in the third embodiment, matters different from those in the first embodiment will be described. Matters the same as those in the first embodiment will be omitted or will be briefly described.

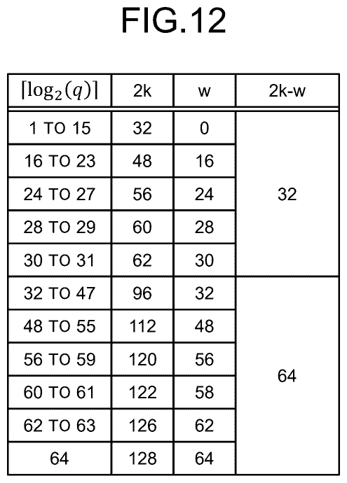

FIG. 12 is a table illustrating an exemplary correspondence relation between the bit length of a value q and various values including a shift amount w according to the third embodiment.

In a case where the bit length of the value q is any of 1 to 15, the shift amount w is zero and the value of 2k is 32. In a case where the bit length of the value q is any of 16 to 23, the shift amount w is 16 and the value of 2k is 48. In a case where the bit length of the value q is any of 24 to 27, the shift amount w is 24 and the value of 2k is 56. In a case where the bit length of the value q is 28 or 29, the shift amount w is 28 and the value of 2k is 60. In a case where the bit length of the value q is 30 or 31, the shift amount w is 30 and the value of 2k is 62. In a case where the bit length of the value q is any of 32 to 47, the shift amount w is 32 and the value of 2k is 96. In a case where the bit length of the value q is any of 48 to 55, the shift amount w is 48 and the value of 2k is 112. In a case where the bit length of the value q is any of 56 to 59, the shift amount w is 56 and the value of 2k is 120. In a case where the bit length of the value q is 60 or 61, the shift amount w is 58 and the value of 2k is 122. In a case where the bit length of the value q is 62 or 63, the shift amount w is 62 and the value of 2k is 126. In a case where the bit length of the value q is 64, the shift amount w is 64 and the value of 2k is 128. In a case where the bit length of the value q is any of 1 to 31, the value of (2k−w) is 32. In a case where the bit length of the value q is any of 32 to 64, the value of (2k−w) is 64.

Thus, the correspondence relation illustrated in FIG. 12 has a configuration in which a part regarding the bit length of the value q that ranges from 1 to 31 in the correspondence relation illustrated in FIG. 3 and a part regarding the bit length of the value q that ranges from 32 to 64 in the correspondence relation illustrated in FIG. 11 are merged together.

In a case where the correspondence relation is set as described above, the number of variations for the shift amount w in the first shift operation is limited to 11 and the number of variations for the shift amount (2k−w) in the second shift operation is limited to two.

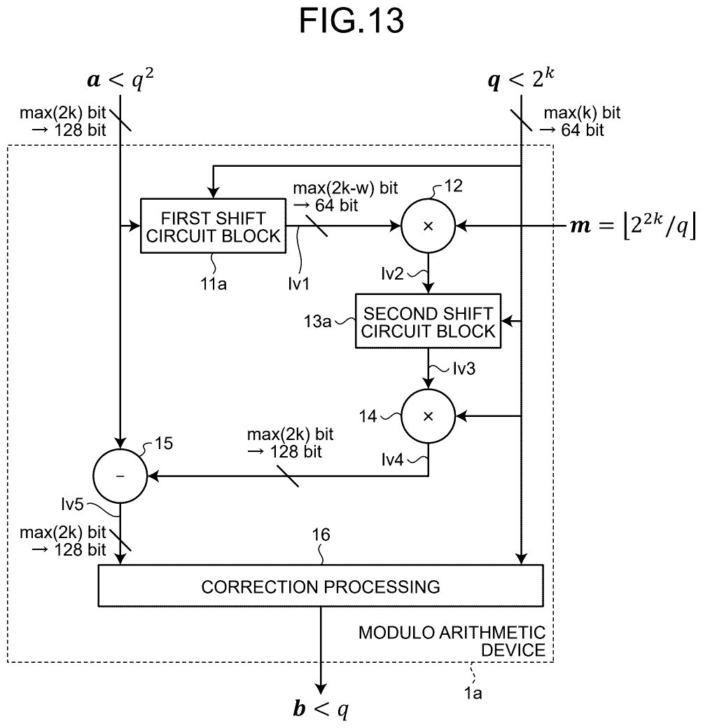

FIG. 13 illustrates an exemplary configuration of a modulo arithmetic device 1a according to the third embodiment. Note that, herein, the correspondence relation illustrated in FIG. 12 is applied.

A value a is input to the modulo arithmetic device 1a through a data path having a 128-bit width. A value q is input to the modulo arithmetic device 1a through a data path having a 64-bit width.

The modulo arithmetic device 1a includes a first shift circuit block 11a, a first multiplication circuit 12, a second shift circuit block 13a, a second multiplication circuit 14, a subtraction circuit 15, and a correction processing circuit 16.

The first shift circuit block 11a performs a shift operation to shift right the value a by a shift amount w. The value of the shift amount w is correlated with the bit length of the value q based on the correspondence relation exemplified in FIG. 12. An intermediate value Iv1 is acquired by the shift operation by the first shift circuit block 11a.

The second shift circuit block 13a performs a shift operation to shift right an intermediate value Iv2 by (2k−w) bits. Here, the value of (2k−w) is correlated with the bit length of the value q based on the correspondence relation exemplified in FIG. 12. An intermediate value Iv3 is acquired by the shift operation by the second shift circuit block 13a.

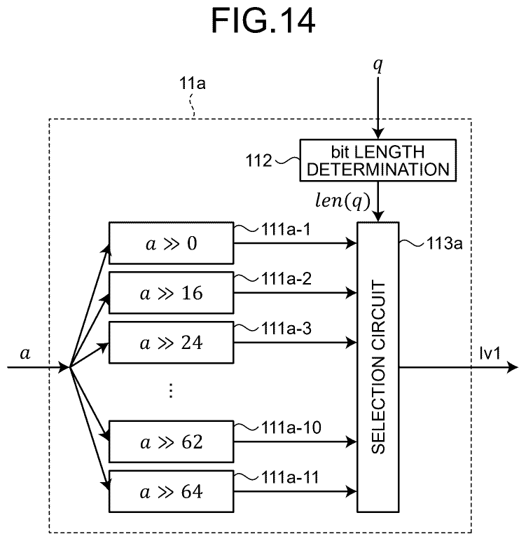

FIG. 14 illustrates an exemplary configuration of the first shift circuit block 11a according to the third embodiment.

The first shift circuit block 11a includes shift circuits 111a, the number of which corresponds to the number of variations for the shift amount w. Thus, the first shift circuit block 11a includes, in total, eleven shift circuits 111a of a shift circuit 111a-1, a shift circuit 111a-2, a shift circuit 111a-3, a shift circuit 111a-4, a shift circuit 111a-5, a shift circuit 111a-6, a shift circuit 111a-7, a shift circuit 111a-8, a shift circuit 111a-9, a shift circuit 111a-10, and a shift circuit 111a-11. Note that some of these shift circuits 111a are omitted in illustration.

The value a is input to each of the eleven shift circuits 111a in common. The eleven shift circuits 111a perform respective shift operations, which are different in shift amount, to the value a. The shift amount in the shift operation that the eleven shift circuits 111a each perform is any of eleven variations for the shift amount w.

Specifically, the shift circuit 111a-1 shifts right the value a by 0 bits. Thus, the shift circuit 111a-1 outputs the value a without any change. The shift circuit 111a-2 shifts right the value a by 16 bits. The shift circuit 111a-3 shifts right the value a by 24 bits. The shift circuit 111a-4 shifts right the value a by 28 bits. The shift circuit 111a-5 shifts right the value a by 30 bits. The shift circuit 111a-6 shifts right the value a by 32 bits. The shift circuit 111a-7 shifts right the value a by 48 bits. The shift circuit 111a-8 shifts right the value a by 56 bits. The shift circuit 111a-9 shifts right the value a by 58 bits. The shift circuit 111a-10 shifts right the value a by 62 bits. The shift circuit 111a-11 shifts right the value a by 64 bits.

The first shift circuit block 11a further includes a bit length determination circuit 112 and a selection circuit 113a. The eleven shift circuits 111a are connected to the selection circuit 113a.

The value q is input to the bit length determination circuit 112. The bit length determination circuit 112 determines the bit length of the value q. The bit length of the value q obtained by the determination is input as a selection signal to the selection circuit 113a.

Based on the selection signal and the correspondence relation exemplified in FIG. 12, the selection circuit 113a selects one of the respective output values output by the eleven shift circuits 111 and then outputs the selected output value as the intermediate value Iv1.

Specifically, in a case where the bit length of the value q is any of 1 to 15, the selection circuit 113a outputs, as the intermediate value Iv1, the output value from the shift circuit 111a-1. In a case where the bit length of the value q is any of 16 to 23, the selection circuit 113a outputs, as the intermediate value Iv1, the output value from the shift circuit 111a-2. In a case where the bit length of the value q is any of 24 to 27, the selection circuit 113a outputs, as the intermediate value Iv1, the output value from the shift circuit 111a-3. In a case where the bit length of the value q is 28 or 29, the selection circuit 113a outputs, as the intermediate value Iv1, the output value from the shift circuit 111a-4. In a case where the bit length of the value q is 30 or 31, the selection circuit 113a outputs, as the intermediate value Iv1, the output value from the shift circuit 111a-5. In a case where the bit length of the value q is any of 32 to 47, the selection circuit 113a outputs, as the intermediate value Iv1, the output value from the shift circuit 111a-7. In a case where the bit length of the value q is any of 48 to 55, the selection circuit 113a outputs, as the intermediate value Iv1, the output value from the shift circuit 111a-8. In a case where the bit length of the value q is any of 56 to 59, the selection circuit 113a outputs, as the intermediate value Iv1, the output value from the shift circuit 111a-9. In a case where the bit length of the value q is 60 or 61, the selection circuit 113a outputs, as the intermediate value Iv1, the output value from the shift circuit 111a-10. In a case where the bit length of the value q is 62 or 63, the selection circuit 113a outputs, as the intermediate value Iv1, the output value from the shift circuit 111a-11. In a case where the bit length of the value q is 64, the selection circuit 113a outputs, as the intermediate value Iv1, the output value from the shift circuit 111a-12.

Since the first shift circuit block 11a has the above configuration, a shift operation is achieved with the shift amount w corresponding to the bit length of the value q based on the correspondence relation exemplified in FIG. 12.

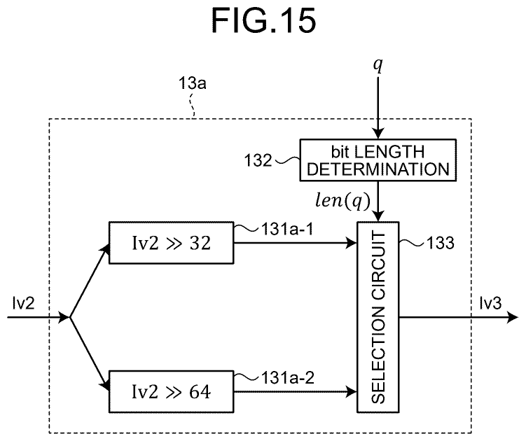

FIG. 15 illustrates an exemplary configuration of the second shift circuit block 13a according to the third embodiment.

The second shift circuit block 13a includes shift circuits 131a, the number of which corresponds to the number of variations for the shift amount (2k−w). Thus, the second shift circuit block 13a includes, in total, two shift circuits 131a of a shift circuit 131a-1 and a shift circuit 131a-2. Therefore, the second shift circuit block 13a can be regarded as including shift circuits 131a whose number is less than the number of variations for the bit length of the value q.

The intermediate value Iv2 is input to each of the two shift circuits 131a in common. The two shift circuits 131a perform respective shift operations, which are different in shift amount, to the intermediate value Iv2. The shift amount in the shift operation that the two shift circuits 131a each perform is either of two variations for the shift amount (2k−w). The shift circuit 131a-1 shifts right the intermediate value Iv2 by 32 bits. The shift circuit 131a-2 shifts right the intermediate value Iv2 by 64 bits.

The second shift circuit block 13a further includes a bit length determination circuit 132 and a selection circuit 133.

The value q is input to the bit length determination circuit 132. The bit length determination circuit 132 determines the bit length of the value q. The bit length of the value q obtained by the determination is input as a selection signal to the selection circuit 133.

Based on the selection signal and the correspondence relation exemplified in FIG. 12, the selection circuit 133 selects one of the respective output values output by the two shift circuits 131a and then outputs the selected output value as the intermediate value Iv3.

Specifically, in a case where the bit length of the value q is any of 1 to 31, the selection circuit 133 outputs, as the intermediate value Iv3, the output value form the shift circuit 131a-1. In a case where the bit length of the value q is any of 32 to 64, the selection circuit 133 outputs, as the intermediate value Iv3, the output value from the shift circuit 131a-2.

Since the second shift circuit block 13a has the above configuration, a shift operation is achieved with the shift amount (2k−w) corresponding to the bit length of the value q based on the correspondence relation exemplified in FIG. 12.

As described above, according to the third embodiment, possible values for the bit length of the value q are correlated with the same value of (2k−w). In other words, the correspondence relation between a possible value for the bit length of the value q and a combination of a possible value for the shift amount w and a possible value for the parameter value k is set such that the value of (2k−w) in a case where the bit length of the value q is a third value is identical to the value of (2k−w) in a case where the bit length of the value q is a fourth value different from the third value.

Therefore, the number of variations for the shift amount (2k−w) in the second shift operation can be made less than the number of variations for the bit length of the value q. Therefore, the modulo arithmetic device 1a that is small in circuit area and can perform a high-speed operation can be achieved.

In addition, according to the third embodiment, as described with FIG. 15, the second shift circuit block 13a includes the shift circuits 131a, the number of which is less than the number of variations for the bit length of the value q, and the selection circuit 133. The intermediate value Iv2 is input to each of the shift circuits 131a in common. Based on the bit length of the value q, the selection circuit 133 selects one of the respective output values output by the shift circuits 131a.

Therefore, the number of variations for the shift amount (2k−w) in the second shift operation can be made less than the number of variations for the bit length of the value q. Therefore, the modulo arithmetic device 1a that is small in circuit area and can perform a high-speed operation can be achieved.

### Fourth Embodiment

According to the first embodiment, the calculation for the value a is performed in the signature processing circuit 102. In a fourth embodiment, a modulo arithmetic device calculates a value a. In the fourth embodiment, matters different from those in the first embodiment will be described. Note that the fourth embodiment can be applied to any of the modulo arithmetic devices 1 and 1a according to the first to third embodiments.

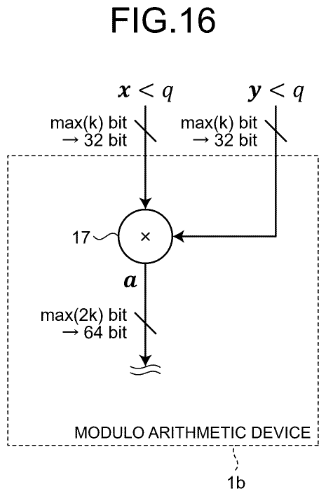

FIG. 16 illustrates an exemplary configuration of a modulo arithmetic device 1b according to the fourth embodiment. The configuration of the modulo arithmetic device 1b is different from the configuration of the modulo arithmetic device 1 according to the first embodiment in that a third multiplication circuit 17 is added.

A value x and a value y are input from outside (e.g., from a signature processing circuit 102) to the modulo arithmetic device 1b. The value x is input to the modulo arithmetic device 1b through a data path whose width is 32 bits corresponding to the maximum possible value for a parameter value k. Similarly, the value y is input to the modulo arithmetic device 1b through a data path whose width is 32 bits corresponding to the maximum possible value for the parameter value k.

The third multiplication circuit 17 multiplies the value x by the value y to acquire a value a. The value a is input to other circuits in the modulo arithmetic device 1b (first shift circuit block 11 and subtraction circuit 15 that are not illustrated in FIG. 16) through a data path having a width of 64 bits.

As described above, the modulo arithmetic device 1b may be configured such that the value x and the value y are input to the modulo arithmetic device 1b. In the modulo arithmetic device 1b, the third multiplication circuit 17 multiplies the value x by the value y to acquire the value a.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A modulo arithmetic device performing a bitwise operation using a dividend a and a divisor q to calculate a remainder, the modulo arithmetic device comprising:
a first shift circuit configured to acquire a first intermediate value by shifting right the dividend a by a shift amount w correlated with a bit length of the divisor q, the shift amount w taking a value equal to or less than the bit length of the divisor q;
a first multiplication circuit configured to acquire a second intermediate value by multiplying the first intermediate value by a value m;
a second shift circuit configured to acquire a third intermediate value by shifting right the second intermediate value by a shift amount (2k−w), k being a parameter value and taking a value equal to or larger than the bit length of the divisor q;
a second multiplication circuit configured to acquire a fourth intermediate value by multiplying the third intermediate value by the divisor q;
a subtraction circuit configured to acquire a fifth intermediate value by subtracting the fourth intermediate value from the dividend a; and
a processing circuit configured to acquire the remainder by subtracting a value n-times the divisor q from the fifth intermediate value, n being an integer of 0 or more.

2. The modulo arithmetic device according to claim 1, wherein
a correspondence relation between:
a possible value for the bit length of the divisor q, and
a combination of a possible value for the shift amount w and a possible value for the parameter value k
is set such that a combination of a value of the shift amount w and a value of the parameter value k in a case where the bit length of the divisor q is a first value becomes identical to a combination of a value of the shift amount w and a value of the parameter value k in a case where the bit length of the divisor q is a second value different from the first value.

3. The modulo arithmetic device according to claim 1, wherein
a correspondence relation between:
a possible value for the bit length of the divisor q, and
a combination of a possible value for the shift amount w and a possible value for the parameter value k
is set such that a value of the shift amount (2k−w) in a case where the bit length of the divisor q is a third value is identical to a value of the shift amount (2k−w) in a case where the bit length of the divisor q is a fourth value different from the third value.

4. The modulo arithmetic device according to claim 2, wherein
a correspondence relation between:
a possible value for the bit length of the divisor q, and
a combination of a possible value for the shift amount w and a possible value for the parameter value k
is set such that a value of the shift amount (2k−w) in a case where the bit length of the divisor q is a third value is identical to a value of the shift amount (2k−w) in a case where the bit length of the divisor q is a fourth value different from the third value.

5. The modulo arithmetic device according to claim 3, wherein
the correspondence relation is set such that the shift amount (2k−w) has a constant value regardless of the bit length of the divisor q.

6. The modulo arithmetic device according to claim 2, wherein
the first shift circuit includes:
shift circuits being different in shift amount, each of the shift circuits being configured to receive input of the dividend a in common, the number of the shift circuits being less than the number of the possible values for the bit length of the divisor q, and
a selection circuit configured to select one of respective output values of the shift circuits based on the bit length of the divisor q, and
the first intermediate value is the one of respective output values selected by the selection circuit.

7. The modulo arithmetic device according to claim 3, wherein
the second shift circuit includes:
shift circuits being different in shift amount, each of the shift circuits being configured to receive input of the second intermediate value in common, the number of the shift circuits being less than the number of the possible values for the bit length of the divisor q, and
a selection circuit configured to select one of respective output values of the shift circuits based on the bit length of the divisor q, and
the third intermediate value is the one of respective output values selected by the selection circuit.

8. The modulo arithmetic device according to claim 1, wherein
the modulo arithmetic device is configured to receive input of a value x and a value y each being smaller than the divisor q, and
the modulo arithmetic device further comprises a third multiplication circuit configured to acquire the dividend a by multiplying the value x by the value y.

9. A memory system comprising:
a nonvolatile memory in which firmware is stored; and
a controller configured to control the nonvolatile memory and perform signature verification processing for the firmware, the signature verification processing including calculation of a remainder based on a bitwise operation using a dividend a and a divisor q, wherein
the controller is configured to, in the calculation of the remainder,
acquire a first intermediate value by shifting right the dividend a by a shift amount w correlated with a bit length of the divisor q, the shift amount w taking a value equal to or less than the bit length of the divisor q,
acquire a second intermediate value by multiplying the first intermediate value by a value m,
acquire a third intermediate value by shifting right the second intermediate value by a shift amount (2k−w), k being a parameter value and taking a value equal to or larger than the bit length of the divisor q,
acquire a fourth intermediate value by multiplying the third intermediate value by the divisor q,
acquire a fifth intermediate value by subtracting the fourth intermediate value from the dividend a, and
calculate the remainder by subtracting a value n-times the divisor q from the fifth intermediate value, n being an integer of 0 or more.

10. The memory system according to claim 9, wherein
a correspondence relation between:
a possible value for the bit length of the divisor q, and
a combination of a possible value for the shift amount w and a possible value for the parameter value k
is set such that a combination of a value of the shift amount w and a value of the parameter value k in a case where the bit length of the divisor q is a first value becomes identical to a combination of a value of the shift amount w and a value of the parameter value k in a case where the bit length of the divisor q is a second value different from the first value.

11. The memory system according to claim 9, wherein
a correspondence relation between:
a possible value for the bit length of the divisor q, and
a combination of a possible value for the shift amount w and a possible value for the parameter value k
is set such that a value of the shift amount (2k−w) in a case where the bit length of the divisor q is a third value is identical to a value of the shift amount (2k−w) in a case where the bit length of the divisor q is a fourth value different from the third value.

12. The memory system according to claim 10, wherein
a correspondence relation between:
a possible value for the bit length of the divisor q, and
a combination of a possible value for the shift amount w and a possible value for the parameter value k
is set such that a value of the shift amount (2k−w) in a case where the bit length of the divisor q is a third value is identical to a value of the shift amount (2k−w) in a case where the bit length of the divisor q is a fourth value different from the third value.

13. The memory system according to claim 11, wherein
the correspondence relation is set such that the shift amount (2k−w) has a constant value regardless of the bit length of the divisor q.

14. The memory system according to claim 10, wherein
the controller includes:
shift circuits being different in shift amount, each of the shift circuits being configured to receive input of the dividend a in common, the number of the shift circuits being less than the number of the possible values for the bit length of the divisor q, and
a selection circuit configured to select one of respective output values of the shift circuits based on the bit length of the divisor q, and
the first intermediate value is the one of respective output values selected by the selection circuit.

15. The memory system according to claim 11, wherein
the controller includes:
shift circuits being different in shift amount, each of the shift circuits being configured to receive input of the second intermediate value in common, the number of the shift circuits being less than the number of the possible values for the bit length of the divisor q, and
a selection circuit configured to select one of respective output values of the shift circuits based on the bit length of the divisor q, and
the third intermediate value is the one of respective output values selected by the selection circuit.

16. The memory system according to claim 9, wherein
the controller is configured to
receive input of a value x and a value y each being smaller than the divisor q, and
acquire the dividend a by multiplying the value x by the value y.
